(19) United States
(12) Patent Application Publication
(10) Pub. No.: US 2024/0367234 A1
(43) Pub. Date: Nov. 7, 2024

(54) ADDITIVE MANUFACTURING METHOD WITH PULSED IRRADIATION FOR A COMPONENT HAVING A DEFINED SURFACE TEXTURE

(71) Applicant: Siemens Energy Global GmbH & Co. KG, Munich, Bayern (DE)

(72) Inventors: Ole Geisen, Berlin (DE); Timo Heitmann, Berlin (DE)

(73) Assignee: Siemens Energy Global GmbH & Co. KG, Munich, Bayern (DE)

(21) Appl. No.: 18/292,907

(22) PCT Filed: Jun. 28, 2022
(86) PCT No.: PCT/EP2022/067636

§ 371 Date: Jan. 28, 2024

(30) Foreign Application Priority Data
Aug. 3, 2021 (DE) 10 2021 208 384.6

(51) Int. Cl. B22F 10/38; B22F 10/28; B22F 10/366; B22F 10/85; B33Y 10/00; B33Y 50/02

(52) U.S. Cl. CPC B22F 10/38; B22F 10/28; B22F 10/366; B22F 10/85; B33Y 10/00; B33Y 50/02; B22F 2998/10

(57) ABSTRACT

A method for selectively irradiating a material layer in additive manufacturing of a component includes the following: providing geometric data, having a contour of a component that is to be additively manufactured, computer-based definition of an irradiation pattern for layers of the component, the irradiation pattern having at least one contour irradiation path in a layer, and wherein an irradiation of the contour irradiation path is superimposed by a pulsed irradiation in the layer for forming a predefined surface texture of the component such that melt baths, which result in the course of the production of the component from an irradiation of the contour irradiation path and such, which result from the pulsed irradiation, overlap. A corresponding additive manufacturing method, a correspondingly manufactured component and a corresponding computer program product are provided.

### CROSS REFERENCE TO RELATED APPLICATIONS

This application is the US National Stage of International Application No. PCT/EP2022/067636 filed 28 Jun. 2022, and claims the benefit thereof, which is incorporated by reference herein in its entirety. The International Application claims the benefit of German Application No. DE 10 2021 208 384.6 filed 3 Aug. 2021.

### FIELD OF INVENTION

The present invention relates to a method of selectively irradiating a material layer in the additive manufacture of a component part or to a corresponding additive manufacturing method, and to a component part producible in said manner. Additionally specified is a computer program product corresponding to the selective irradiation.

The component part is preferably intended for use in the hot gas pathway of a gas turbine. For example, the component part relates to a component to be cooled that has a thin-wall or intricate design. Alternatively or additionally, the component part may be a component for use in automobility or in the aviation sector.

### BACKGROUND OF INVENTION

High-performance machine components are the subject of constant improvement in order in particular to increase their efficiency in use. In the case of thermal engines, especially gas turbines, however, this is leading to ever higher use temperatures among other outcomes. The metallic materials and the component design of component parts that can be subjected to high stress, such as turbine blades, are the subject of constant improvement with regard to their strength, lifetime, creep resistance and thermomechanical fatigue.

Because of technical development, additive manufacturing is also of increasing interest for the mass production of the abovementioned component parts, for example turbine blades or burner components.

Additive manufacturing methods, also referred to colloquially as 3D printing, include, for example, as powder bed methods, selective laser melting (SLM) or laser sintering (SLS), or electron beam melting (EBM). Further additive methods are, for example, directed energy deposition (DED) methods, in particular laser deposition welding, electron beam or plasma powder welding, wire welding, metallic powder injection molding, sheet lamination methods, or thermal spraying methods (VPS/LPPS, GDCS).

A method of selective laser melting with pulsed irradiation is known, for example, from EP 3 542 927 A1.

Additive manufacturing methods have especially been found to be particularly advantageous for complex or intricate component parts, for example labyrinth-like structures, cooling structures and/or lightweight structures. In particular, additive manufacturing is advantageous by virtue of a particularly short chain of process steps, since a production or manufacturing step for a component part can be effected largely on the basis of a corresponding CAD (computer-aided design) file and the selection of appropriate manufacturing parameters.

The manufacturing of gas turbine blades by means of the described powder-bed-based methods (“LPBF” for “laser powder bed fusion”) advantageously enables the implementation of new geometries or concepts which reduce the manufacturing costs or the construction and throughput time, optimize the manufacturing process, and can improve, for example, a thermomechanical design or durability of the components.

Components manufactured in a conventional manner, for example by casting, are significantly inferior to the additive manufacturing route, for example in terms of their freedom of shaping and also in relation to the required throughput time and the associated high costs, and also the manufacturing-related complexity.

However, the powder bed process inherently gives rise to high thermal stresses in the structure of the component part. In particular, irradiation pathways or vectors that are too short lead to significant overheating, which in turn leads to warpage of the structure. Significant warpage during the construction process easily leads to structural detachments, thermal deformations or geometric variances outside a permissible tolerance.

In particular, complex surfaces requiring high spatial resolution can be manufactured by AM, especially LPBF, but are difficult or even impossible to model by computer-assisted construction (in CAD). Even if such CAD modeling were possible, the associated level of data-related demands would be disproportionately high and impracticable.

Customary component part dimensions are frequently several hundreds of millimeters; the complex surface features mentioned, by contrast, are required in orders of magnitude below 200 μm. The limiting factor for such “surface features” is the melt bath geometry. The acceleration and deceleration of the beam focus (“laser spot”) along vectors to be scanned-in accordance with a fixed irradiation pattern-affects the melt bath size and often makes it impossible to describe very small features, for example those with a dimension of less than three times or twice a corresponding (conventional) melt bath diameter.

Furthermore, the description of tailored surface features or a predetermined surface texture is made more difficult in that the melt bath in the powder bed inherently expands or “draws” adjacent powder particles into it.

### SUMMARY OF INVENTION

It is therefore an object of the present invention to solve the problems described and in particular to specify a means by which a finely resolved surface texture can be achieved in additively manufactured component parts.

This object is achieved by means of the subject matter of the independent claims. The dependent claims relate to advantageous configurations.

One aspect of the present invention relates to a method of selectively irradiating a material layer, especially powder layer, in the additive manufacture of a component part, comprising the providing of (layer-by-layer) geometry data, comprising a contour of a component part to be additively manufactured.

The “contour” may be an edge of a solid-material region in the respective layer of the component part to be irradiated or else a thin-wall structure, such as a thin wall, which is described only via a single irradiation pathway (“single scan”).

The method further comprises the computer-assisted and optionally computer-implemented defining or providing of an irradiation pattern for layers, especially at least one, more than one or all layers, of the component part, wherein the irradiation pattern in a layer comprises at least one contour irradiation pathway, wherein an irradiation of the contour irradiation pathway for formation of a predefined surface texture or surface topography of the component part is superposed with a (further) pulsed irradiation in the layer such that there is an overlap of melt baths that arise in the course of production of the component part from an irradiation of the contour irradiation pathway and those that arise from the pulsed irradiation.

The overlap mentioned is appropriate especially for production of a coherent component part structure (having layer-by-layer coherence).

The superposition mentioned in the irradiations, irradiation pathways or irradiation vectors is primarily a spatial overlap of the irradiation vectors or of the resulting melt baths, although the irradiations may also coincide in terms of time.

The “contour irradiation pathway” described in the present context shall preferably describe a contour region of the component part which is to undergo irradiation once or more than once (in parallel vectors). In technical jargon, such irradiations are frequently referred to in the slang as “contour runs”.

It is advantageously a feature of the solution described that it actually makes it possible at all to enable complex, functional and/or spatially highly resolved surface features or textures in additively manufactured component parts. This in turn allows the implementation of tailored surfaces, for example for description of functional cooling structures having an increased surface area, or with regard to the influencing of fluidic surface properties, for example of turbulator or agitator components.

In addition, means are provided for tailoring surfaces for joining or coating applications or for implementing esthetic, holographic and/or optical surface properties. In addition again, an exploitation of such surface properties can be exploited in additively manufactured sensory component parts, for example with regard to binding or absorption properties for biological cell growth or the like.

In one configuration, the defined surface structure has not been or is not described in the (CAD) geometry data of the component part.

In one configuration, the contour irradiation pathway is continuously irradiated in the course of production of the component part. In this configuration, it is possible to exploit the advantages of a continuous irradiation, i.e. of a greater processing efficiency and also of a greater structural stability of the contour.

In one configuration, the contour irradiation pathway is irradiated in a pulsed manner in the course of production of the component part. In this configuration, by contrast, it is possible to exploit the advantages of a pulsed irradiation, with regard to the formation of a particularly fine structure and/or the avoidance of excessively large heat inputs into the contour.

In one configuration, the contour defines a thin-wall region of the component part, such as a thin wall, a film, a lamella or, for example, a set of bellows, in which case the contour irradiation pathway for structural description of the contour is irradiated along just one (single) contour irradiation vector. According to the present invention, this contour irradiation vector may then, however, be defined, and irradiated, in a pulsed and/or continuous manner.

In one configuration, the surface texture caused by an irradiation along the irradiation pattern-in the course of production of the component part-has a regular waveform, for example according to a second-order geometric deviation. The waveform described allows the correspondingly textured surface to be advantageously tailored to the above-described requirements of the surface.

The same applies to a further configuration, according to which the surface texture caused by the irradiation along the irradiation pattern has a (regular or irregular) zigzag progression.

In one configuration, the pulsed irradiation is effected along contour irradiation vectors parallel to the contour irradiation pathway.

In one configuration, the component part has regions of a solid structure, wherein the irradiation pattern, for the description of said solid structure, has area irradiation vectors (called “hatches”) in the corresponding layer.

In one configuration, melt baths that arise from an irradiation of the area irradiation vectors and those that arise from the irradiation of/along the contour irradiation pathway are overlap-free, or offset in an overlap-free manner. In this configuration, it is advantageously possible to prevent superposition of melt baths of the area irradiation and those of the contour irradiation, which can impair the surface topology, topography or trueness to scale of the component part.

In one configuration, an interspace between (coherent) melt baths from the area irradiation, i.e. the irradiation of the area irradiation vectors, and melt baths from the contour irradiation (irradiation of the contour irradiation pathways), for a coherent component part structure, is closed by a further, filling irradiation or by melt baths caused by this. By virtue of this configuration, it is appropriately possible to generate a coherent and hence dimensionally stable component part structure.

A further aspect of the present invention relates to an additive manufacturing method, comprising the method of selective irradiation (as described), wherein the selective irradiation is effected by means of a laser or an electron beam, and the material layer is a powder layer.

In one configuration, the material layer consists of a nickel-or cobalt-based superalloy. In this configuration, the solution presented relates primarily to a use of high-performance materials that makes particular demands on additive manufacture or corresponding selective irradiation, and with which, in particular, the quality and freedom of configuration of textured surfaces has to date constituted a particular challenge.

In one configuration, the component part is a component to be employed in the hot gas pathway of a turbomachine.

A further aspect of the present invention relates to a component part which is producible or has been produced in accordance with the solution presented, and which still comprises surface features in at least one (spatial) dimension of less than twice or three times a (conventional) melt bath diameter of a continuous irradiation.

Alternatively or additionally, said component part, according to the solution described, can be provided with surface features that measure less than 200 μm in at least one dimension.

A further aspect of the present invention relates to a computer program or computer program product comprising commands which, on execution of the program by a computer, for example to control the irradiation in an additive manufacturing system, cause it to perform the selective irradiation according to the defined irradiation pattern as described in the present context.

A CAD file or a computer program product may, for example, be provided or exist in the form of a (volatile or nonvolatile) storage or reproduction medium, for example a memory card, a USB stick, a CD-ROM or DVD, or else in the form of a file downloadable from a server and/or in a network. Provision can also be effected, for example, in a wireless communication network via the transmission of a corresponding file with the computer program product. A computer program product may include program code, machine code or numerical control instructions such as G-code and/or other executable program instructions in general.

In one configuration, the computer program product relates to manufacturing instructions by which an additive manufacturing system, for example via means of CAM (“computer-aided manufacturing”) by a corresponding computer program, is controlled for production of the component part.

The computer program product may also contain geometry data and/or construction data in a data set or data format, such as a 3D format or in the form of CAD data, or comprise a program or program code for provision of these data.

Configurations, features and/or advantages that relate in the present context to the method for irradiation or production may also relate to the component part directly or to the computer program product, and vice versa.

The expression “and/or” or “or” used here, when used in a series of two or more elements, means that any of the listed elements can be used alone, or any combination of two or more of the listed elements can be used.

Further details of the invention are described below with reference to the figures.

### BRIEF DESCRIPTION OF THE DRAWINGS

FIG. 1 indicates, by a schematic section diagram, the basic principle of powder-bed-based additive manufacturing methods.

FIG. 2 indicates, by a schematic view, an irradiation pattern according to the present invention.

FIG. 3 indicates, similarly to FIG. 2, an alternative irradiation pattern for the production of a component part according to the present invention.

FIG. 4 indicates an illustrative wavy surface texture according to the invention.

FIGS. 5 and 6 each also indicate an illustrative inventive contour irradiation pathway according to the present invention.

### DETAILED DESCRIPTION OF INVENTION

In the working examples and figures, elements that are the same or have the same effect can each be provided with the same reference signs. The elements shown and their proportions to one another should fundamentally not be considered to be true to scale; instead, individual elements can be shown in exaggerated thickness or with large dimensions for better presentability and/or for better understanding.

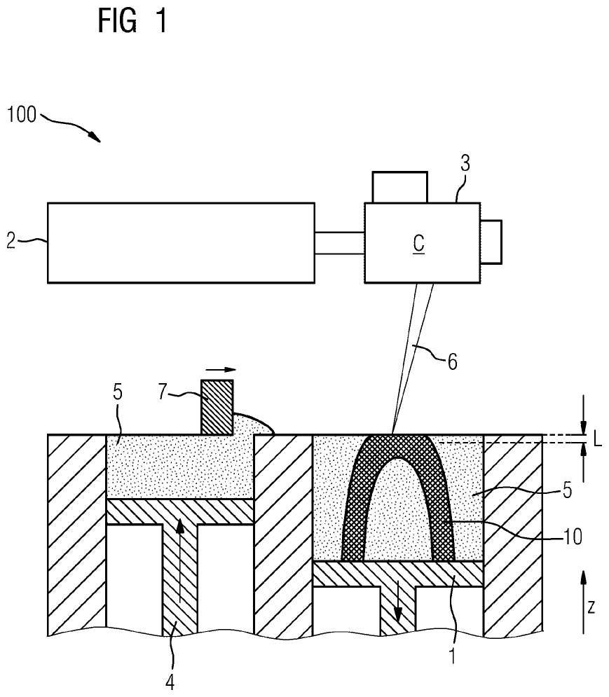

FIG. 1 shows an additive manufacturing system 100. The manufacturing system 100 is preferably designed as an LPBF system and for the additive building of component parts or components from a powder bed. The system 100 may specifically also relate to a system for electron beam melting.

Accordingly, the system has a build platform 1. A component part 10 to be additively manufactured is created layer by layer on the build platform 1 from a powder bed. The latter is formed by a powder material 5 which can be distributed layer by layer on the build platform 1, for example by means of a reciprocating piston 4 and then a coater 7.

After each powder layer L has been applied, regions of the layer are selectively melted with an energy beam 6, for example a laser or electron beam, and then solidified according to the defined geometry of the component part 10. In this way, the component part 10 is built layer by layer in the build direction z shown.

The energy beam 6 preferably comes from a beam source 2 and is scanned across each layer L in a location-selective manner by means of a scanner or controller 3.

After each layer L, the build platform 1 is preferably lowered by an amount corresponding to the layer thickness (cf. the arrow pointing downward on the right in FIG. 1). The thickness L is typically only between 20 μm and 40 μm, and so the entire process can easily include the selective irradiation of thousands up to tens of thousands of layers. It is possible here for the only very locally active energy input to result in the occurrence of high temperature gradients, for example of 106 K/s or more. A tension state of the component part is of course also correspondingly large during the build and thereafter, which generally considerably complicates additive manufacturing processes.

The component part 10 may be a component part of a turbomachine, for example a component part of a hot gas pathway of a gas turbine. In particular, the component part may be a blade or vane, a ring segment, a burner chamber or burner part, such as a burner tip, a frame, a shield, a heat shield, a nozzle, a seal, a filter, an opening or lance, a resonator, a die or an agitator, or a corresponding transition, insert, or a corresponding retrofit part.

The geometry of the component part is typically fixed by a CAD file. After such a file has been read into the manufacturing system 100 or the controller thereof, the process then first requires the establishment of a suitable irradiation strategy, for example by means of CAM, as a result of which the component part geometry is also divided into the individual layers. Accordingly, the inventive measures described hereinafter may also already be expressed by a computer program product C in the additive manufacture of material layers. For this purpose, the computer program product C preferably comprises commands which, in the execution of a corresponding program or method by a computer, or the controller 3, cause it to perform the selective irradiation of the presently described irradiation pattern M.

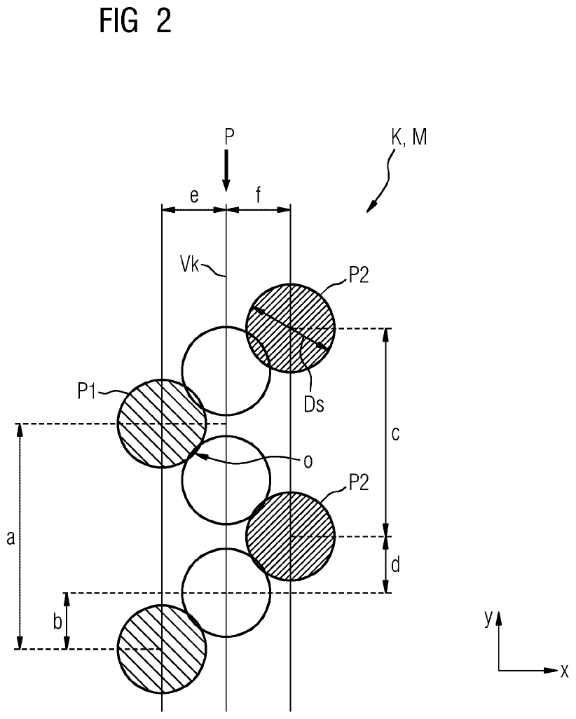

FIG. 2 shows, in a top view of a material layer (cf. layer extent in the x-y plane), a corresponding irradiation pattern M for selective irradiation of a contour K as part of a component part region which is built layer by layer according to the principle shown in FIG. 1.

The contour K is essentially defined by a contour irradiation pathway P, which extends from the top downward in FIG. 2. The pathway P is indicated by a continuous line and may, in accordance with the invention, be irradiated by a continuous irradiation or else in a pulsed manner, as indicated by the circular, spaced-apart melt baths in FIG. 1 (not indicated explicitly).

Preferably, the contour K, in this configuration, defines a thin-wall region of the component part 10 that can be described only by a contour irradiation vector Vk. As is well known, the achievable wall thickness of the final component part structure is defined essentially by a melt bath dimension. Alternatively, it is also possible to conduct multiple (parallel) contour irradiations.

According to the invention, the contour K is preferably likewise provided by geometry data.

The present method thus further comprises the preferably computer-assisted defining of the irradiation pattern M, which comprises at least one contour irradiation pathway P in the form of layers.

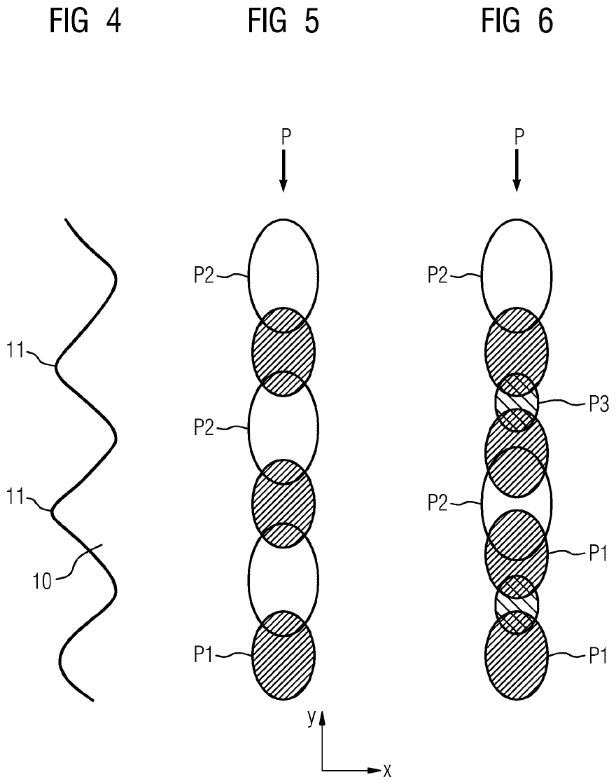

In order to form a particular or defined surface texture (cf. also FIG. 4 further down), the contour irradiation pathway P is also superposed with a pulsed irradiation P1 (on the left-hand side in the image) and P2 (on the right-hand side in the image) in such a way that there is an overlap of melt baths that arise in the course of production of the component part from an irradiation of the contour irradiation pathway and those that arise from the pulsed irradiation P1, P2. A corresponding overlap is identified in FIG. 2 by the reference sign o.

The pulsed irradiation or pulsation P1 is effected with a pulse separation a and in pathway direction with an offset b-relative to pulses of the contour irradiation pathway.

Analogously, the pulsed irradiation or pulsation P2 is effected with a pulse separation c and in pathway direction with an offset d-relative to pulses of the contour irradiation pathway. The offset d corresponds to an opposite offset direction from the offset c.

The pulsation P1 and the pulsation P2 in the present context preferably still run parallel to the identified contour irradiation vector Vk of the pathway P.

By virtue of the described overlap o of corresponding melt baths (cf. melt bath diameter Ds), the irradiation pulses P1 and P2 appropriately connect melt baths of the contour irradiation pathway P.

In an alternative configuration which is not identified explicitly, the pulses P1 and P2 can be superposed with contact on a continuous melt bath of a (continuous) contour irradiation vector Vk.

Merely for the sake of simplicity, the melt baths shown in the irradiation pattern M according to FIG. 2 are all labeled with the same dimensions or diameters. Without restriction of generality, the melt baths may of course, in accordance with the invention, vary according to pulsation and irradiation pathway and be altered by an altered beam energy.

It is made clear that the surface texturing achievable by the present invention is imparted only in the course of preparatory manufacture, by means of CAM, but preferably not already by a construction of the component part 10 or corresponding CAD geometry data.

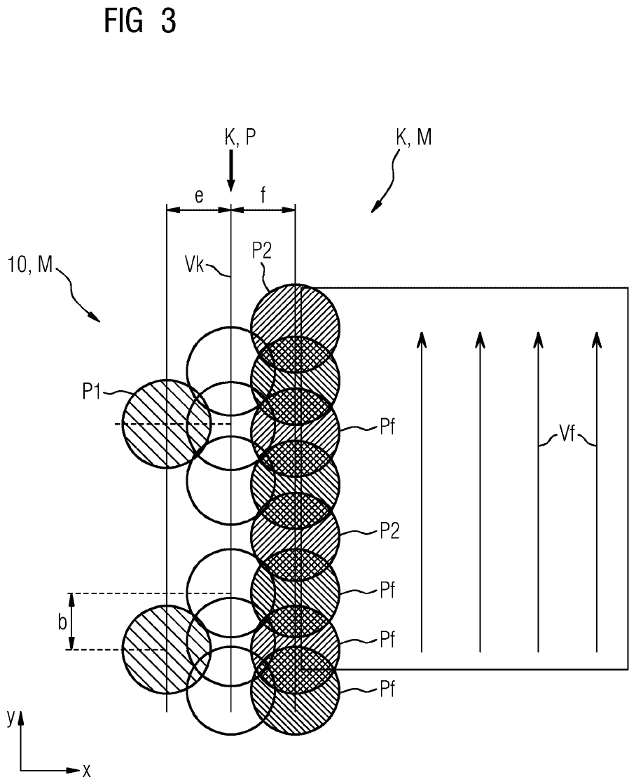

FIG. 3 shows—similarly to FIG. 2—an irradiation pattern M—also containing a contour irradiation pathway P—for a component part layer with a solid region. The selective irradiation of such solid-state layers typically comprises the definition of area irradiation vectors Vf (cf. to the right).

Shown spaced apart on the left from the irradiation pattern for the solid region (not labeled explicitly) in FIG. 3 is again the contour irradiation pathway P of the contour K.

There is preferably no overlap of melt baths that arise from an irradiation of the area irradiation vectors Vf and those that arise from the irradiation of the contour irradiation pathway P, such that this also does not cause any structural distortions or differences in topology of the component part, especially as a result of excessive heat inputs into the layer. Instead, the result is preferably an interspace between the melt baths mentioned, which, for an ultimately coherent component part structure, is closed by a further filling irradiation Pf.

FIG. 4 shows—likewise in a top view—a schematic wavy progression of a surface texture produced in the manner described. The texture tips or surface features labeled with the reference sign 11 preferably correspond to the pulsation P1 according to FIGS. 2 and 3. In addition, the surface texture may have a corresponding zigzag progression and be configured in a desired manner by means of the described solution for description of tailored functional surfaces.

For this purpose, the component part may finally have the surface features 11 described in functional surfaces. A single surface feature 11 or a corresponding oscillation length, dimension or period of a single zigzag progression may preferably correspond to three times or twice a melt bath diameter Ds of a continuous irradiation, or even less.

In absolute measures, a dimension of the described surface features 11 may, for example, be less than 300 μm, less than 200 μm or even less than 100 μm. Because of the above-described difficulty of controlling melt bath dimensions, such values have been impossible to date without the inventive solution.

FIGS. 5 and 6, using schematic irradiation profiles, each indicate an alternative configuration of the inventive solution. While the melt baths having dimensions resulting from the corresponding (pulsed) energy inputs in the diagrams described above were configured in the same way, the pulse parameters may also vary in accordance with the invention. This means that it is then also possible to control the corresponding melt bath extent and the surface properties of the component part structure.

FIG. 5 shows a contour irradiation pathway similar to FIGS. 2 and 3. In the case of the pathway P indicated here, different pulse lengths P1 and P2 are employed, and there may be variation in corresponding pulse parameters, such as energy input, (spatial and/or temporal) pulse separation or else scan speed. For example, the melt baths indicated in circular form that result from the pulsation P1 are smaller than the elongated or elliptical melt baths that are caused by the pulses P2. As a result, it is likewise possible to achieve a tailored surface texture.

A configuration similar to FIG. 5 is shown in FIG. 6, in which it is actually possible to employ three different pulses P1, P2 and P3 and correspondingly different pulse parameters and different melt bath dimensions in order to appropriately configure the surface features of the component part layer thus formed.

In FIGS. 5 and 6 too, it is apparent that the different melt bath dimensions, according to the invention, can result in waviness, for example, of the surface.

1.-13. (canceled)

14. A method of selectively irradiating a material layer (L) in an additive manufacture of a component part, comprising:
providing geometry data comprising a contour of a component part to be additively manufactured,
computer-assisted defining of an irradiation pattern (M) for layers of the component part,
wherein the irradiation pattern (M) in a layer (L) comprises at least one contour irradiation pathway (P),
wherein an irradiation of the contour irradiation pathway (P) for formation of a predefined surface texture of the component part is superposed with a pulsed irradiation (P1, P2) in the layer such that there is an overlap of melt baths that arise in the course of production of the component part from an irradiation of the contour irradiation pathway and those that arise from the pulsed irradiation (P1, P2),
wherein the surface texture caused by an irradiation along the irradiation pattern (M) has a regular waveform and/or a zigzag progression,
wherein the predefined surface texture is not described in the geometry data (CAD) of the component part.

15. The method as claimed in claim 14,
wherein the contour irradiation pathway (P) is subjected to continuous or pulsed irradiation in the course of production of the component part.

16. The method as claimed in claim 14,
wherein the contour (K) defines a thin-wall region of the component part, and
wherein the contour irradiation pathway (P) for structural description of the contour (K) is irradiated along just one contour irradiation vector (Vk).

17. The method as claimed in claim 14,
wherein the pulsed irradiation is effected along contour irradiation vectors (Vk, P1, P2) parallel to the contour irradiation pathway (P).

18. The method as claimed in claim 14,
wherein the component part has regions of a solid structure, and
wherein the irradiation pattern (M) comprises area irradiation vectors (Vf) for the description of the solid structure.

19. The method as claimed in claim 18,
wherein melt baths that arise from an irradiation of the area irradiation vectors (Vf) and those that arise from the irradiation of the contour irradiation pathway (P) are overlap-free.

20. The method as claimed in claim 19,
wherein an interspace between melt baths from the area irradiation (Vf) and melt baths from the contour irradiation (Vk), for a coherent component part structure, is closed by a further filling irradiation (Pf).

21. An additive manufacturing method, comprising:
the method as claimed in claim 14,
wherein the selective irradiation is effected by means of a laser or an electron beam, and the material layer (L) is a powder layer.

22. The additive manufacturing method as claimed in claim 21,
wherein the material layer (L) consists of a nickel-or cobalt-based superalloy, and
wherein the component part is a component to be employed in a hot gas pathway of a turbomachine.

23. A component part produced by the method as claimed in claim 14, comprising:
surface features in at least one dimension of less than twice a melt bath diameter (Ds) of a continuous irradiation.

24. A component part produced by the method as claimed in claim 14, comprising:
surface features in at least one dimension of less than 200 μm.

25. A computer program product stored on a non-transitory computer-readable medium, comprising:
commands stored thereon, which, on execution of the program by a computer, cause the computer to perform the method defined in claim 14.
